(19) United States
(12) Patent Application Publication
(10) Pub. No.: US 2008/0198026 A1
(43) Pub. Date: Aug. 21, 2008

(54) Warning System

(76) Inventor: Graham Hatton-Downward, Cheshire (GB)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/720,294

(22) PCT Filed: Nov. 28, 2005
(86) PCT No.: PCT/GB05/04548

§ 371 Date: Nov. 6, 2007

(30) Foreign Application Priority Data
Nov. 26, 2004 (GB) 0426065.9

(51) Int. Cl. G08B 21/00

(52) U.S. Cl. 340/614

(57) ABSTRACT

Warning system for a SCUBA diving apparatus that emits a first visible indication when the pressure in the tank falls below a first predetermined level and a second visible indication when the pressure in the tank falls below a second predetermined level which is lower than the first predetermined level. The warning system (10) is mountable on the first stage (14) of the SCUBA regulator.

### FIELD OF INVENTION

The present invention relates to a warning system, and in particular a warning system for use when diving. In particular, the system is useful for use with self contained underwater breathing apparatus (SCUBA).

### BACKGROUND TO THE INVENTION

When SCUBA diving, each diver carries their own supply of breathable gas in a tank. During the dive, the diver will breathe gas from the tank. The diver must return to the surface before all the breathable gas, such as compressed air, in their tank has been used. Since the rate at which different divers will use the gas from their tanks will vary, being dependent upon the fitness and technique of the diver, it is necessary for divers to know how much breathable gas remains in their tank. For this reason, it is usual for divers to have a pressure gauge indicating the pressure within their tank, and thereby indicating the amount of gas remaining in the tank. When the pressure within the tank reaches a predetermined level, the diver should surface.

Especially when learning to dive, divers are required to advise their instructors when the pressure in their tanks reaches a first predetermined level, for example 2000 psi (around 14×10⁹ Pa) or even 1500 psi (around 10×10⁹ Pa). This enables the instructor to know when any of the divers are running low on breathable gas. Divers are required to advise their instructor when the pressure in their tanks reaches a second predetermined level, for example 1000 psi (around 7×10⁹ Pa). At this point, the dive will be ended, and all divers will be required to surface.

Unfortunately, many divers learning to dive will not advise their instructor when the pressure in their tanks falls to the predetermined levels. This may be because the divers do not check the pressure of their tanks frequently or accurately enough, or because the divers do not want to advise the instructor that they are running low of breathable gas as they do not wish the dive to end. In either case, there is the risk that the dive instructor will not know when any of the divers are running low of breathable gas, and accordingly there is the risk that one or more divers in the party may run out of breathable gas whilst underwater. Therefore, the dive instructor will usually need to swim between the divers, and individually check their pressure gauges at frequent intervals.

Although there is a particular problem with divers when they are learning to dive, for any dive there is always a dive leader. It is important that the dive leader is aware of low levels of breathable gas in the tanks of other divers. With conventional systems requiring each diver to check the pressure in their own tanks, and advise the dive leader when the pressure falls to predetermined levels, there is the risk that the dive leader will not be advised accurately when the pressure in any other diver's tank reaches a predetermined level, and accordingly the dive leader may not be able to end the dive at the right time.

As well as the very serious risk that individual divers may run out of breathable gas while underwater, this may also affect other divers in the dive party who may have to expose themselves to danger or risk in trying to rescue a diver who runs out of breathable gas. Further, for organised dive parties, there is a risk that the dive leader may be sued in the event of injury or death of a diver who has run out of breathable gas while underwater, which may have resulted from the individual diver not advising the dive leader that their supply was low.

U.S. Pat. No. 6,054,929 describes a device for giving a visual or audible warning to a diver, such as a dive instructor, when the pressure in the tank of another diver falls below a predetermined level. According to the disclosure in this patent, the pressure within a diver's tank is detected by a pressure sensor, connected to one of the high-pressure outputs of the first reducer stage of a two-stage breathing apparatus. The detected pressure is transduced, for example using a circuit that converts the detected pressure into a pulse signal or by the use of an electrical circuit that transmits a detected pressure from an analog or digital pressure gauge. The transduced signal is then used to illuminate a light emitting diode provided either on a known SCUBA diving computer that is worn on the diver's wrist, or on a pressure gauge provided on the end of a whip line from the first stage reducer of the diver's tank. In this way, when the air pressure within the diver's tank reaches a pre-critical or critical pressure, such as 100 bar or 50 bar respectively, the LED will light up allowing the instructor to be warned that the air pressure within another diver's tank has reached a predetermined level.

### SUMMARY OF THE INVENTION

According to the present invention, a warning system for use with SCUBA diving apparatus comprises a pressure sensor for sensing the pressure within a tank of the SCUBA diving apparatus, a light source for emitting a first visible indication when the detected pressure falls below a first predetermined level, and a light source for emitting a second visible indication, different from the first visible indication, when the detected pressure falls below a second predetermined level, the second predetermined level being lower than the first predetermined level, in which the system is arranged to be mounted directly onto the first stage of a SCUBA regulator.

In accordance with the present invention, the warning system is designed to be mounted directly onto the regulator which controls the flow of breathable gas from the tank. This is distinct from the arrangement described in U.S. Pat. No. 6,054,929 in which the detected pressure is used to produce a warning either on a pressure gauge provided on a whip line, or on a computer worn by the diver on the wrist. With both of the prior art methods, the precise location of the display, and the orientation of any visual display, will be dependent upon the position of the pressure gauge on the end of the whip line, or on the position of the diver's wrist. In either case, this position will vary, as will the direction of the transmitted warning. By providing the warning display from a fixed point, namely from the regulator, the dive instructor will always known where to look to see whether the pressure in any of the divers' tanks has reached a first or second predetermined level. This therefore makes it much easier for the dive instructor or dive leader to be aware of a low pressure condition. Also, this helps avoid the risk that the dive instructor will be looking for a low pressure warning, but will not see this because any visual indication will not be directed towards the dive instructor or dive leader, as could happen when the visual warning comes from a device on a whip line or on a divers wrist.

The first and second visible indications may be from a single light source. In this case, the light source may be controlled so that the first and second visible indications are different, for example by varying the frequency or pulse rate of the emitting light. Alternatively, the different first and second visible indications may be achieved by use of different light sources. As an example, the first visible indication may be in the form of a pulse light beam, whilst the second visible indication may be in the form of a continuous light beam.

In one example, the first and second predetermined pressure levels may be variable, and therefore could be set by the dive leader or dive instructor. In this case, the pressure levels may be set dependent upon the dive conditions, or upon the experience of the divers. However, it is preferred that the first and second predetermined pressure levels are preset, and are not variable. This has the advantage that the dive leader does not need to remember the predetermined pressure level settings for each dive, since these will always be the same. Further, by having preset pressure levels that cannot be adjusted, the manufacture of the warning system can be easier and less expensive.

In the preferred example, the first predetermined pressure level is set at 2000 psi (about 14×10⁹ Pa) or 1500 psi (about 10×10⁹ Pa), and the second predetermined pressure level is set to 1000 psi (about 7×10⁹ Pa).

It is preferred that the warning system is provided within a housing that can be screwed directly into the high-pressure port of the SCUBA regulator. However, an adapter may be provided to enable the warning system housing to be coupled to ports of different size found on different SCUBA regulators.

It is preferred that the visible indications are in the form of intense beams of light. This has two major advantages over other visual indications. Firstly, the beams of light can easily be seen by other divers, and therefore it is difficult to miss any indication that one of the other divers in the group has a low pressure in their tank. Secondly, the intense beam of light helps locate the diver. In the case that the diver has become stuck under water, and is running low on breathable gas, the pressure within the tank will be less than the second predetermined pressure level, and accordingly the visible indication will be given. Where this is in the form of a beam of light, a rescuer or other diver could follow in the beam of light to its source and thereby locate and potentially help the stricken diver. This would not be possible where a low intensity visual indication is given.

### BRIEF DESCRIPTION OF THE DRAWINGS

An example of a warning system according to the present invention will be described, by way of example, with reference to the accompanying drawings, in which:

FIG. 1 shows a perspective view of a warning system according to the present invention; and,

FIG. 2 shows an example of the warning device when provided on the regulator of a SCUBA diving apparatus being worn by a diver.

### DETAILED DESCRIPTION OF A PREFERRED EXAMPLE

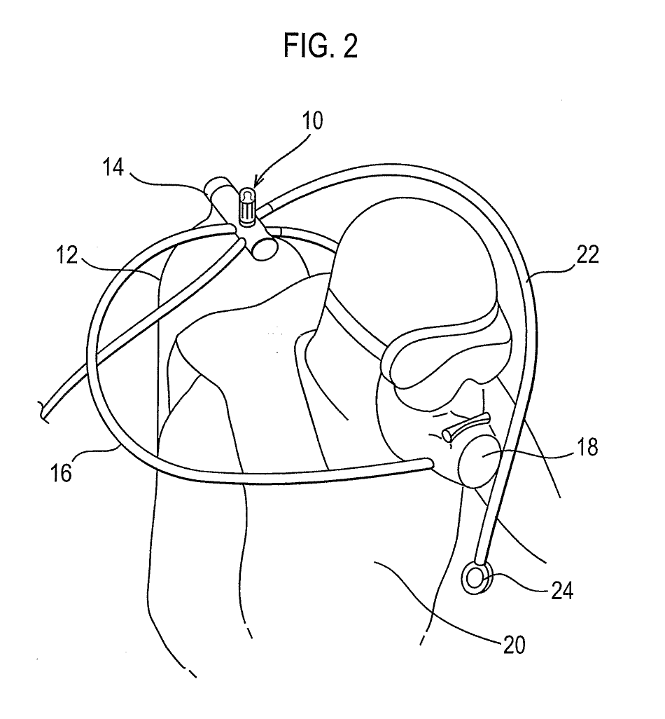

As best shown in FIG. 2, a SCUBA diver 20 will wear a SCUBA diving tank 12 on his back. The diving tank 12 contains a compressed breathable gas, hereinafter referred to as compressed air. The regulator 14 is provided on the tank, and controls the supply of air from the tank to a mouthpiece 18 via a connecting tube 16. The regulator 14 has a low pressure output port to which the connecting tube 16 is coupled, and reduces the high-pressure of the compressed air contained within the tank 12 to a lower pressure for supply to the mouthpiece 18. The regulator 14 also includes a high-pressure output port to which a pressure gauge 24 may be coupled via a tube 22. The pressure gauge 24 gives a visual indication to the diver of the pressure of compressed air within the tank.

As shown in FIG. 2, a warning system 10 according to the present invention is connected directly to another high-pressure output port of the regulator 14. When the pressure within the tank falls below predetermined levels, a visual indication is given of this by the warning system 10. As can be seen in FIG. 2, due to the location of the warning system mounted directly to the regulator, and accordingly in a fixed position relative to the regulator and the tank, any warning indication given by the warning system will come from known position.

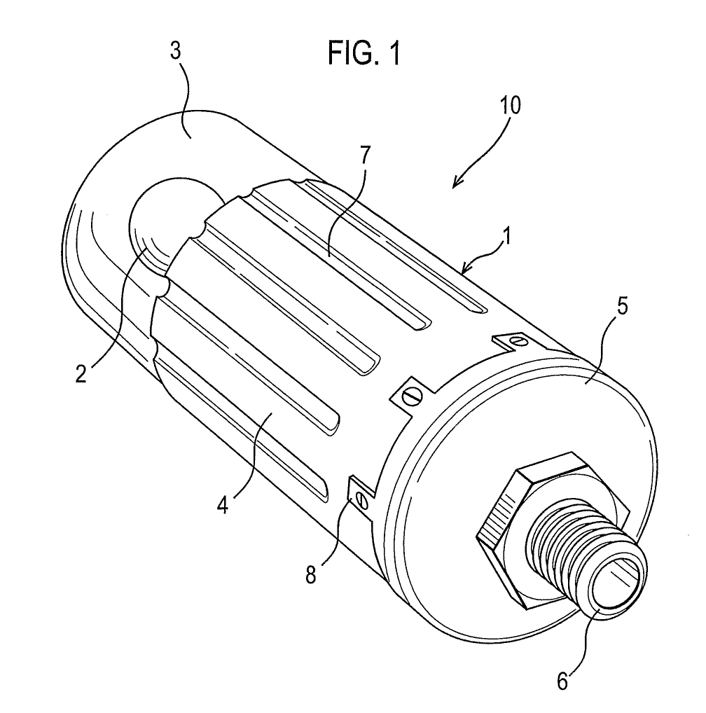

The warning system 10 is shown in the greater detail in FIG. 1. As can be seen, the warning system 10 is provided within a housing 1. This housing may include a transparent section 3 within which a light source 2 is provided. The remainder of the housing 1 need not be transparent.

The housing includes a short connecting piece 6 which is able to be screwed directly into a high-pressure output port of the regulator 14. Since the size of the connecting piece 6 may differ from the size of the output port of a given regulator 14, a step up or stepdown adapter may be required to enable the warning system 10 to be screwed into the output port of the regulator 14. The connection between the warning system 10 and the regulator 14 is such that the high-pressure gas from the tank 12 passes into the warning system 10 through the connecting piece 6 so that the pressure can be detected by a pressure sensor (not shown) provided within the housing 1.

The pressure sensor provided within the housing 1 detects the pressure of the gas within the tank. A determination is made to determine whether the detected pressure is less than the first predetermined threshold pressure level, which may be either preset or adjusted to around 2000 psi (abut 14×10⁹ Pa) or around 1500 psi (about 10×10⁹ Pa). If the pressure detected is below the first level, the light source 2 is controlled to give the first visual indication. The detected pressure is also compared to a second predetermined pressure, lower than the first predetermined pressure. The second pressure level may be preset or adjusted to around 1000 psi (about 7×10⁹ Pa). If the detected pressure is less than the second predetermined pressure, the light source 2 is controlled in a different manner to give the different visual indication.

The comparison of the detected pressure with the first and second predetermined threshold levels may be achieved by any suitable means, for example by an electrical circuit that converts the pressure into an electrical signal which is compared to first and second threshold signals corresponding to the first and second predetermined pressure levels. The control of the light source is again controllable through a suitable electrical circuit, for example controlling the light source 2 to produce an intermittent beam of light when the pressure level detected is below the first pressure level but above the second pressure level, and to control the light source 2 to emit a constant beam of light when the pressure detected is below the second predetermined threshold level. Alternatively, a plurality of different light sources may be provided, one of the light sources being activated when the pressure detected falls below the first predetermined level, and an additional or different light source being activated when the pressure detected falls below the second predetermined level.

It will be appreciated that a power supply is required for the electrical circuits and the light source or light sources. This is preferably provided in the form of a battery within the housing 1 of the warning system 10, and this battery is preferably a rechargeable battery.

The shown in FIG. 1, the main body of the housing 1 may include grooves 7 or other features to assist with the gripping and twisting of the warning system 10 to allow this to be coupled and uncoupled from the regulator 14. This may be particularly useful when the warning system 10 is to be removed from the regulator 14 at the end of the times, when the warning system 10 will be wet. Also shown in FIG. 1, the housing may include a removable end 5, connected to the remainder of the housing by screws or other suitable connecting elements 8 enabling access to be workings of the warning system.

1. A warning system for use with a SCUBA diving apparatus comprising:
a pressure sensor for sensing the pressure within a tank of the SCUBA diving apparatus;
a light source for emitting a first visible indication when the detected pressure falls below a first predetermined level; and,
a light source for emitting a second visible indication, different from the first visible indication, when the detected pressure falls below a second predetermined level, the second predetermined level being lower than the first predetermined level,
in which the warning system is arranged to be mounted onto a first stage of a SCUBA regulator of the SCUBA diving apparatus.

2. A warning system according to claim 1, in which the light source for emitting the first visible indication and the light source for emitting the second visible indication are the same light source.

3. A warning system according to claim 2, in which the light source is controlled so that the first and second visible indications are different.

4. A warning system according to claim 1, in which the light source for emitting the first visible indication and the light source for emitting the second visible indication are different light sources.

5. A warning system according to claim 1, in which the first visible indication is in the form of a pulsed light beam, and the second visible indication is in the form of a continuous light beam.

6. A warning system according to claim 1, in which the first and second visual indications comprise light beams of different colour.

7. A warning system according to claim 1, in which the first and second predetermined pressure levels are variable, and therefore could be set by a dive leader or dive instructor.

8. A warning system according to claim 1 in which the first and second predetermined pressure levels are preset.

9. A warning system according to claim 8, in which the first predetermined pressure level is set to about 2000 psi (about 14×10⁹ Pa).

10. A warning system according to claim 8, in which the first predetermined pressure level is set to about 1500 psi (about 10×10⁹ Pa).

11. A warning system according to claim 9 in which the second predetermined pressure level is set to about 1000 psi (about 7×10⁹ Pa).

12. A warning system according to claim 1, in which the warning system is provided within a housing that can be screwed into a high-pressure port of the SCUBA regulator.

13. A warning system according to claim 12, further comprising an adapter to enable the warning system housing to be coupled to ports of different size found on different SCUBA regulators.

14. (canceled)
